(19) United States
(12) Patent Application Publication
(10) Pub. No.: US 2017/0317572 A1
(43) Pub. Date: Nov. 2, 2017

(54) AC - DC Electric Power Generation

(71) Applicant: WILLIAM B. DEVEER, Federal Way, WA (US)

(72) Inventor: WILLIAM B. DEVEER, Federal Way, WA (US)

(21) Appl. No.: 15/498,425

(22) Filed: Apr. 26, 2017

Related U.S. Application Data
(60) Provisional application No. 62/328,585, filed on Apr. 27, 2016.

(51) Int. Cl. H02K 47/14; H02K 53/00

(52) U.S. Cl. CPC H02K 47/14; H02K 53/00; Y10S 74/09

(57) ABSTRACT

A new combination of existing technologies that turns an Alternator, in order to generate electricity, where the Alternator of the present day is designed with the same design principles as the 1896 Tesla Generator. In addition, due to a new combination of existing technologies, electricity is generated utilizing the Tesla Generator, without pollution causing gasoline or diesel engines, nor connection to the electric grid, and, without the need for wind-power nor hydro-power. Thus, electricity is generated when needed, anytime, anywhere, without the need for an internal combustion engine, nor forces of nature such as wind & water.

### CROSS REFERENCE TO RELATED APPLICATIONS

The enclosed Non-provisional Patent Application is related to Provisional Patent Application No. 62/328,585 filed on Apr. 27, 2016 by the present inventor William B. Deveer, that has the following Title: 2016 Electric Power Generation, which is incorporated by reference into this non-provisional patent application.

### FEDERALLY SPONSORED RESEARCH & DEVELOPMENT

The enclosed invention is not sponsored by any federally funded research & development program.

### NAMES OF THE PARTIES TO A JOINT RESEARCH AGREEMENT

Not Applicable.

### STATEMENT REGARDING PRIOR DISCLOSURES BY THE INVENTOR

The present inventor William B. Deveer hereby states that, the instant invention was disclosed one year or less before the filing date of the claimed invention, as evidenced by Provisional Patent Application No. 62/328,585 filed on Apr. 27, 2016 by the present inventor William B. Deveer, that has the following Title: 2016 Electric Power Generation. Therefore, the claimed invention is not considered as Prior Art, as written under MPEP Section 2153.

### BACKGROUND OF THE INVENTION

The enclosed electric power generation apparatus is a new & novel combination of existing technologies, that enables the production of electricity utilizing the Tesla Generator, that was patented in 1896. The enclosed invention turns the Tesla Generator, thereby generating electricity, without the need for gasoline or diesel engines, nor wind-power, nor hydro-power, as required by most Prior Art inventions. Thus, electricity can be generated when needed, anytime, anywhere, without using the internal combustion engine, that creates harmful air-pollution.

In the present day, the main form of electric power generation is through the 1896 Tesla Generator, a design that is incorporated into large Hydro-electric Turbines, Wind-Turbines, and all gasoline & diesel generators. Even the Alternator used in all automobiles in the present day, to generate mobile electric power, is a version of the Tesla Generator, that is turned at the required RPM by the automobile-engine.

The problem associated with the instant invention is that, it does have a low efficiency rating of 19%, as described in the following pages. However, it is an operable, functioning invention, that generates electricity through turning the Tesla Generator, without using an internal combustion engine, nor wind-power, nor hydro-power, as written in the main claim of this patent application. In addition, a high-efficiency invention is not a requirement for approval, as seen in prior art applications. Prior Art utility patents have been approved where, “a small degree of utility is sufficient” (MPEP Sec. 2107.) Other prior art utility patents have been allowed where, “a commercially successful product is not required” for approval (MPEP Sec. 2107.)

DISCUSSION OF PRIOR ART: Prior Art patents utilized gasoline or diesel engines to turn an Alternator, as seen in U.S. Pat. No. 8,525,492 B2 granted on Sep. 3, 2013 to Peterson et al., Inventors. In this patent, multiple Alternators are turned at the required RPM, by an internal combustion engine which uses either gasoline or diesel fuel.

There have been other Prior Art patent applications that have attempted to patent a method to turn the Tesla Generator, without the need for an Internal Combustion Engine. However, these patent applications were not granted due to several reasons under Patent Law.

1. In U.S. patent application Ser. No. 12/539,180 with a Filing Date of Aug. 11, 2009 (Publication No. 2010/0156114 A1—dated: Jun. 24, 2010) filed by the Inventor Stanley Huntington, the Application was not approved due to the following reasons.
a. The Huntington invention is comprised of an Electric Power Generator that is turned with an electric motor powered by a battery or from an electric outlet, where the mechanical energy from the electric-motor is transferred to the Generator via a bicycle derailleur connected with a chain. Here, we see a hypothetical invention that was most likely denied due to Inoperability, by the Examiner. Inoperability of the invention is a reason for denial of the Patent as written by Patent Attorney David Pressman, in his book: Patent It Yourself, 14th Edition, 2009, Nolo Press, Publisher.
b. The Huntington invention further does not show Enablement, since it is a hypothetical invention that is a combination of incompatible technologies. A person skilled in the art would not be able to construct a working prototype of the invention. Due to lack of Enablement, the Patent Examiner is required to deny the Application, as written in the Patent Examiner's Manual.
c. The Huntington Application does include the concept of using a percent of the output of the Generator to power the electric-motor. However, the generation of electricity without the need for an internal combustion engine, is not claimed in the Claims Section of the Application. The inventor could not claim this concept, since it is a hypothetical idea of an invention, instead of a working invention, which is a requirement for approval of a Patent Application.

2. Another prior art U.S. patent application, that was found on a search at www.google.com, is application Ser. No. 11/009,798 with a Title of: Dynamotor Electric Generator, filed by Robert William Jackson, Inventor. This Application can be viewed at the following website: www.thelivingmoon.com/41pegasus/33roberts_files/Dynamoto_Electric_Generator_11-009798.html
a. In the Jackson Application, the inventor has combined an electric motor connected to a Generator with a belt-drive. The electric-motor is said to be connected to a power source in the Claims, but does not specify what kind of power source.
b. The Jackson Application includes the concept of a percent of the output of the Generator being used to power the electric-motor, in the Description Section of the Invention. However, this concept is not claimed in the Claims Section of the Application. In addition, generation of electricity without using an internal combustion engine is not claimed in the Claims Section of the Application.
c. In addition, the inventor has clearly written in the Jackson Application, that he has not yet constructed the invention, that, it is a theory of a new invention. The inventor has written: “I'm in the process of trying to do this,” of trying to construct the invention, on page 3 of the Application.
d. The Jackson Application further does not show Enablement, where a person skilled in the art can build a working prototype. There is no specific information on what type of electric motor & generator is required, in order to build the invention. Generators require a high amount of torque, in order to turn the generator at the required RPM. There is also no torque information on the electric motor. Thus, the Jackson Application was most likely denied, due to In-operability & lack of Enablement, by the Examiner.
e. The Huntington & Jackson Applications were denied by the Examiner for the reasons stated in the previous paragraphs. In comparison, the instant invention is a new combination of existing technologies, that is a functioning invention that generates electricity without an internal combustion engine, as claimed in the Claims Section. Furthermore, the instant invention is a different combination (than that described in the Huntington & Jackson Applications), of compatible technologies utilizing a v-belt pulley, the standard automotive v-belt & Alternator, and, utilizing a high-torque cordless electric drill to turn the Alternator, thereby generating electricity.

### BRIEF SUMMARY OF THE INVENTION

The instant invention turns the Tesla Generator by utilizing the efficient & high-torque Direct Current (DC) motor within a cordless drill, that is powered by a starter-battery, which turns an Alternator, in order to create electricity. The mechanical energy from the cordless drill is transferred to the Alternator through a v-belt drive pulley & a standard automotive v-belt. A loop of current is created where the output of the Alternator is used to charge batteries, which in-turn, powers the efficient cordless electric drill. Therefore, electricity is generated using the Tesla Generator, without utilizing gasoline or diesel engines, nor wind-power, nor hydro-power.

Since 1896, the Tesla Generator has been turned at the required RPM, thereby generating electricity, using gasoline & diesel engines, and, with Hydro-power & Wind-power.

The instant invention has several advantages over prior art inventions. The claimed invention's specific utility is that, it generates electricity using the Tesla Generator exclusively, without the need for an internal combustion engine, nor wind-power, nor hydro-power, nor connection to the electric grid (Electricity can be generated in other ways, without using the Tesla Generator, such as solar power.)

In addition to the specific utility of the instant invention as described in the previous paragraph, the claimed invention has substantial utility, where electricity is generated anytime, anywhere, without the need for gasoline or diesel engines, nor wind-power, nor hydro-power. An important additional advantage is that, the instant invention does not cause harmful air pollution. These advantages are substantial, where the claimed invention will benefit the public in it's present form, without further development, as described further in the following paragraph. Thus, the instant invention has a specific & substantial utility to the public, thereby meeting the utility requirements under MPEP section 2107.

The instant invention in it's present form, without further development, can be used as a demonstration prototype of a new power generation methodology, for review by private sector Research & Development (R & D) institutes, and, government organizations such as the Department of Energy, in order to gain funding for large scale R & D into this new method of power generation that does not cause air pollution, where electricity is generated without the need for internal combustion engines, nor wind-power, nor hydro-power, thereby creating an immediate benefit for the public.

Furthermore, in addition to having specific & substantial utility, the instant invention also has “Practical Utility” as written in MPEP Section 2107, where it provides “some immediate benefit to the public,” due to the advantages & characteristics of the claimed invention, as described in the previous paragraphs.

### BRIEF DESCRIPTION OF THE SEVERAL VIEWS OF THE DRAWING

FIG. 1 shows the claimed invention in it's entirety, as seen from front & above of the apparatus. Cordless-Drill 16 is seen on the lower right, that drives Alternator 7 through v-belt pulley 14 & automotive v-belt 11. The output of Alternator 7 is then connected to storage batteries 2 & 24 on the lower left. Then, a system of powering Cordless-Drill 16 from Batteries 2 & 24 through 20 volt Batteries 22 & 21, is seen in the lower left & lower front of FIG. 1.

FIG. 2 is an enlarged overhead view of Hole-Saw Attachment 15 connected to the v-belt pulley 14 through Drive-Shaft 33. FIG. 2 further shows the placement of Steel-Bolt 27 that is held in place by Stainless-steel Hose Clamp 28. Steel-Bolt 27 securely attaches Hole-Saw Attachment 15 & Right Angle Bracket 29 to Drive-Shaft 33. FIG. 2 also shows v-belt pulley 14 being securely attached to Drive-Shaft 33 using set-screw 30, via Keyway 32.

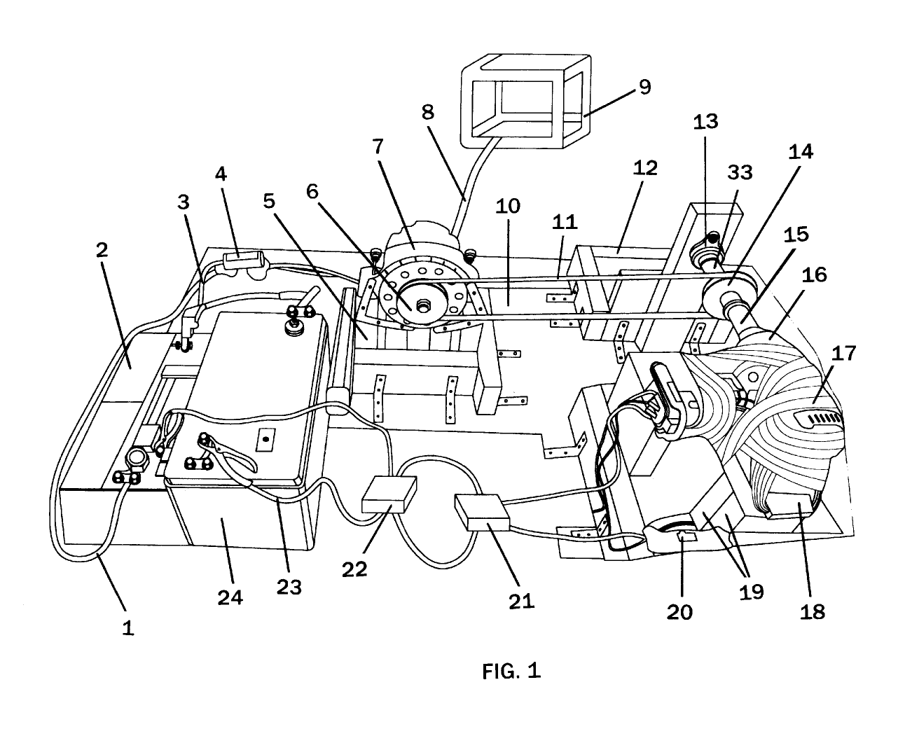

FIG. 1 shows Cordless-Drill 16 is affixed to Mounting Frame 18. An enlarged angled view from the front of Mounting Frame 18, is shown in FIG. 3, to which Cordless-Drill 16 is securely affixed, using Three-step Method 17. FIG. 3 clearly shows the different 2×4 sections that comprise this Mounting Frame, and, how Cordless-Drill 16 is positioned over the Mounting Frame.

### DETAILED DESCRIPTION OF THE INVENTION

FIG. 1 shows the AC-DC Electric Power Generation apparatus, where a 20 Volt DC Cordless-Drill 16, a DeWALT DCF898B, contains a 677 N.m (500 ft·lbs) high-torque, efficient motor, with a power consumption of 5.0 amps at 20 Volts DC (=100 Watts.) The DeWALT DCF898B accepts 11.11 mm ( 7/16 in) Hex attachments, such as Hex Drill Bits, and Hex Hole Saw Attachments.

FIG. 1 further shows Cordless-Drill 16 mounted on a heavy-duty Mounting Frame 18 made of pressure-treated 50.8 mm×101.6 mm (2 in×4 in) wooden studs. Cordless-Drill 16 is affixed to Mounting Frame 18 with a Three-Step Method 17 comprising of Jute Cord, which has good grip, that is wound around Mounting Frame 18 as an initial binding of Cordless-Drill 16 to Mounting Frame 18. The second step is to utilize 79 kg (175 lb) plastic ties that are used to further strengthen & bind Cordless Drill 16 to Mounting Frame 18. The third step is to use vinyl electrical tape, that is affixed over the 79 kg (175 lb) plastic ties & the Jute Cord, and, wound around the 2×4 sections of Mounting Frame 18, which adds a third layer of strength. Mounting Frame 18 is securely attached to a 609 mm×914 mm (24 in×36 in) Wooden-Board 10 using right angle brackets & steel screws, as shown in FIG. 1.

FIG. 1 further shows Cordless Drill 16 is attached to a 28.575 mm (1⅛ in) diameter, Hex Hole-Saw Attachment 15. A 25.4 mm (1 in) diameter steel, keyed, Drive-Shaft 33, is fitted through the 25.40 mm (1 in) diameter Bore of a 88.9 mm (3.5 in) diameter v-belt pulley 14, and, same Drive-Shaft 33 is then fitted into the hollow tubing of Hole-Saw Attachment 15. The other end of Drive-Shaft 33 is fitted into a 25.4 mm (1 in) diameter flange-type Ball-Bearing 13 (available at www.zoro.com.) Ball-Bearing 13 is affixed to a heavy-duty Mounting-Frame 12 that is made of pressure-treated 50.8 mm×101.6 mm (2 in×4 in) wooden studs. Mounting-Frame 12 is attached securely to Wooden-Board 10 using right angle brackets & steel screws, as shown in FIG. 1.

FIG. 1 further shows a 38.10 mm (½ in) automotive v-belt 11 is placed into the v-belt groove of v-belt pulley 14, with the other end of same v-belt 11 being inserted into the v-belt groove of an 80 mm (3.15 in) diameter v-belt drive wheel 6 of Alternator 7. Alternator 7 is grounded to a dedicated ground comprised of a rectangular metal frame 9, with 4.11 mm diameter (6 gauge) copper wire 8, where metal frame 9 is made of 25.4 mm (1 in) diameter metal tubing, with the dimensions of metal frame 9 being 609 mm×457 mm×457 mm (24 in×18 in ×18 in.) Alternator 7 is a wind turbine Permanent Magnet Alternator that was adapted for a motor driven system with an 80 mm (3.14 in) diameter v-belt drive wheel 6 attached to the drive-shaft of Alternator 7.

FIG. 1 further shows Alternator 7 attached to a heavy-duty Mounting-Frame 5 made from pressure-treated two-by-four wooden studs. Mounting-Frame 5 is attached securely to Wooden-Board 10 using right angle brackets & steel screws, as shown in FIG. 1. The positive & negative outputs of Alternator 7, made of 4.11 mm diameter (6 ga.) cables, is then attached to the inputs of in-line Wattmeter 4, then, at the output of Wattmeter 4, additional lengths of positive cable 1 & negative cable 3, made of 4.11 mm diameter (6 ga.) cables, are connected to a 12 volt DC automotive Battery 2. A 6 volt Battery 24 is connected in series to the 12 volt Battery 2, in order to create an 18 volt DC battery pack.

FIG. 1 further shows 18 volt DC battery pack, comprised of 12 volt DC Battery 2 & 6 volt DC Battery 24, is connected to twin 20 volt DC Batteries 21 & 22, with 1.0237 mm diameter (18 ga.) wire, that limits the amperes from the 18 volt battery pack. 20 volt DC Batteries 21 & 22 are connected in parallel in order to maintain the required voltage to power Cordless-Drill 16. 20 volt DC Batteries 21 & 22 further have 2 outputs, an 18 volt DC output that directly powers the efficient motor within the DeWALT DCF898B, and, a 6 volt DC output that powers the electronic controls of the DeWALT DCF898B. The 18 volt DC battery pack is connected to the 18 volt DC connections of the twin 20 volt DC Batteries 21 & 22, thereby continuously charging the 18 volt section of same batteries. Since the 6 volt section is integrated into the same 20 volt DC Batteries 21 & 22, then the 6 volt section is also continuously charged by the 18 volt DC battery pack (comprised of 12 volt DC Battery 2 & the 6 volt DC Battery 24 in series), without the need for the standard 110 volt A/C battery charger, that takes upto 1 hour to charge a 5 amp 20 volt DC battery.

FIG. 1 further shows the 18 volt DC positive output from 20 volt DC Battery 21, is connected via 1.0237 mm diameter (18 ga.) wire to on/off Switch 20, which is in-turn, connected to the 18 volt DC positive terminal of cordless-drill 16 (comprised of a large copper spade terminal) with alligator clips, that are held in place with hot melted glue from a glue-gun. The built-in on/off trigger switch of Cordless-Drill 16 is depressed into a permanent On position with a 20 kg (45 lb) plastic tie that is wound around the trigger-switch & handle-grip of Cordless-Drill 16. Thus, when Switch 20 is turned to the On position, Cordless-Drill 16 is also turned to the On position. The 18 volt DC negative output from 20 volt DC Battery 21 is connected via 1.0237 mm diameter (18 ga.) wire directly to the 18 volt DC negative terminal of Cordless-Drill 16 (comprised of a large copper spade terminal) with alligator clips, that are held in place with hot melted glue from a glue-gun. (The 6 volt DC positive & negative outputs from Battery 21 were connected directly via 0.6438 mm (22 ga.) copper wire, to the positive & negative 6 volt terminals of Cordless-Drill 6 (comprised of smaller silver spade terminals), with alligator clips held in place with hot melted glue from a glue-gun.)

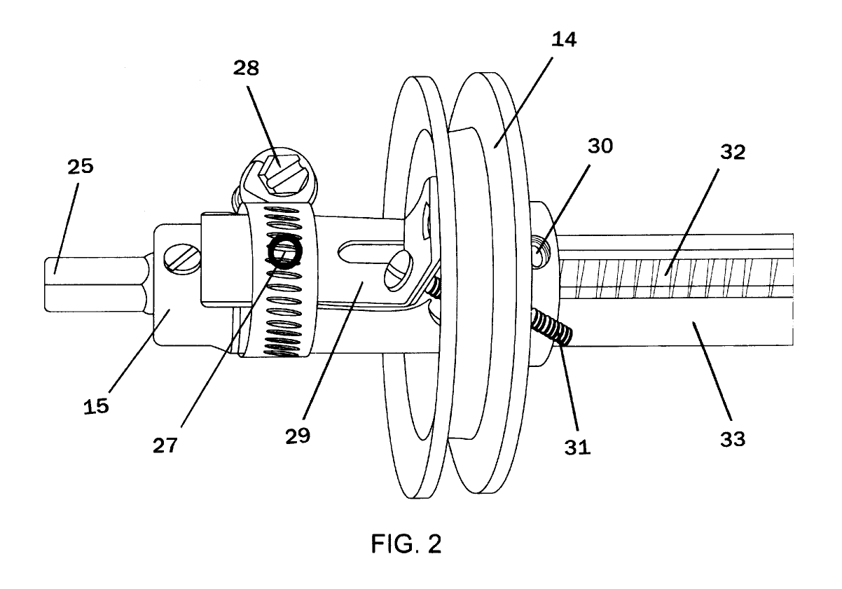

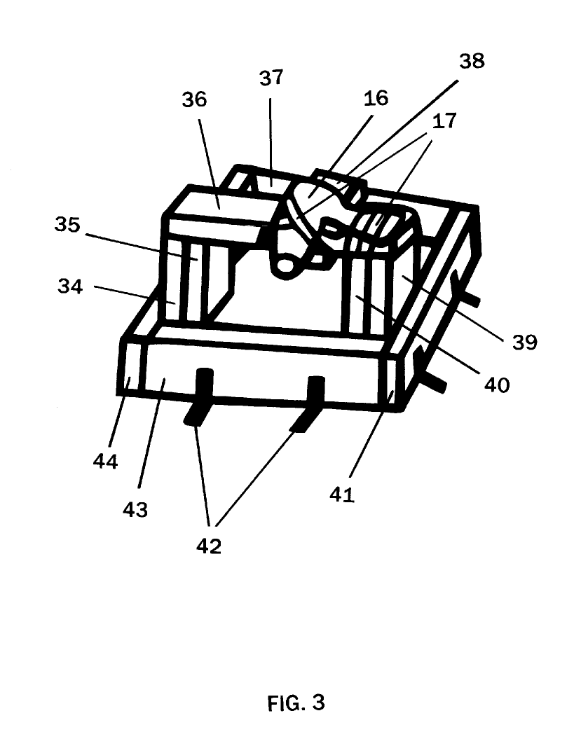

FIG. 2 shows a detailed view of the Drive-system that is comprised of a 11.11 mm ( 7/16 in) Hex Shaft 25, that fits into the Hex-chuck of Cordless Drill 16 (FIG. 1.) Hex Shaft 25 is part of 28.575 mm (1.125 in) diameter Hole-saw Attachment 15, wherein a 25.40 mm (1 in) diameter Drive-Shaft 33 is inserted into the hollow tubing of Hole-saw Attachment 15. A Right-Angle Bracket 29 is placed over Hole-saw Attachment 15, directly over Keyway 32 of Drive-Shaft 33. A 6.35 mm (¼ in) diameter hole was drilled into Right-Angle Bracket 29 & Hole-saw Attachment 15 with Cobalt & Steel drill bits, and, a 6.35 mm (¼ in) diameter Steel-Bolt 27 was inserted through the 6.35 mm (¼ in) diameter holes that were drilled through Right-Angle Bracket 29 & Hole-saw Attachment 15. Steel-Bolt 27 was cut with diamond coated circular saw electric drill attachments available at www.harborfreight.com, into a length that allows for an exact fit from the top of Right-Angle Bracket 29, through Hole-saw Attachment 15, and down to the bottom of the Keyway 32 of Drive-Shaft 33.

FIG. 2 further shows a stainless-steel hose clamp 28 placed over the flat-head of Steel-Bolt 27 and around Drive-Shaft 33, in order to keep Steel-Bolt 27 securely in place. Steel-Bolt 27 serves as a set-screw for Right-Angle Bracket 29 & Hole-saw Attachment 15.

FIG. 2 further shows a 6.35 mm (¼ in) diameter Steel-Bolt 31 is placed through a 6.35 mm (¼ in) diameter hole drilled into Right-Angle Bracket 29 & same Steel-Bolt 31 is placed through a 6.35 mm (¼ in) diameter hole drilled into v-belt pulley 14. Steel-Bolt 31 & Right Angle Bracket 29 function as an additional binding of Hole-saw Attachment 15 to v-belt pulley 14.

FIG. 2 further shows v-belt pulley 14 is securely attached to Drive-Shaft 33 through set-screw 30, that securely attaches v-belt pulley 14 to Keyway 32. Hole-Saw Attachment 15, Right-Angle Bracket 29, Hose-Clamp 28, Steel-Bolt 27 & Steel-Bolt 31, are further bonded together with J-B Weld epoxy compound that has a bonding strength of 4400 psi.

FIG. 1 further shows Cordless-Drill 16 attached to Mounting Frame 18, which is made from 50.8 mm×101.6 mm (2 in×4 in) wooden studs that are cut to precise sections with a Skil HD3834 fixed circular saw with an aluminum cutting blade. A detailed view of Mounting Frame 18 is shown in FIG. 3.

FIG. 3 is comprised of a rectangular base formed by two sections 43 & 37 (made with 2×4 wooden sections) that are 285 mm (11.22 in) in length, that are opposite to each other. The other two sections 44 & 41, of the rectangular base, are 315 mm (12.40 in) in length. Then, four 152 mm (5.98 in) vertical sections 34, 35, 40, & 39 are attached to the rectangular base of the Mounting Frame, with 2 in steel screws, with two 152 mm (5.98 in) sections being attached to sections 44 & 41 of the rectangular base.

FIG. 3 is further comprised of a 285 mm (11.22 in) horizontal section 36 that is attached with steel screws on top of the two legs made from the 152 mm (5.98 in) vertical sections 34, 35, 39, & 40, on top of which, the front of Cordless-Drill 16 is positioned. Then, another 220 mm (8.66 in) section 38 is attached with steel screws, below & in the center of Horizontal section 36, at a perpendicular angle of 90 degrees, with the other end of section 36 placed on top of two 125 mm (4.92 in) vertical sections in the rear of the mounting frame, that are not visible in FIG. 3. However, these 125 mm (4.92 in) vertical sections are visible in FIG. 1 (shown by reference no. 19), that form the third leg of the support for cordless-drill 16 (with the rear of Cordless-Drill 16 positioned above, as shown in FIG. 1.)

FIG. 1 further shows a flange-type Ball-Bearing 13 available at www.zoro.com, attached to Mounting Frame 12 with two bolts and nuts. Mounting Frame 12 is made from 50.8 mm×101.6 mm (2 in×4 in) wooden sections, where a square base is formed with four sections with a length of 220 mm (8.66 in) each, attached with steel screws. In the front of this square base, another 220 mm (8.66 in) section is placed on top of the 220 mm (8.66 in) section (of the square base), in front. Then, both 220 mm (8.66 in) sections are attached to a 330 mm (12.99 in) vertical section, with steel screws. Ball-Bearing 13 is attached 40 mm (1.57 in) below the top of the 330 mm (12.99 in) vertical section with 2 steel bolts. Mounting Frame 12 is then attached to Wooden-Board 10 with 6 right-angle steel brackets (2 brackets on each side) using steel screws, as shown in FIG. 1. Only 6 brackets are used for Mounting Frame 12, since it is mounted at the edge of 609 mm×914 mm (24 in×36 in) Wooden-Board 10, and there is no room for the right angle brackets on the fourth side of the square base of Mounting-Frame 12.

FIG. 1 further shows the dedicated Mounting-Frame 5 for Alternator 7 that is comprised of precision-cut sections of pressure-treated 50.8 mm×101.6 mm (2 in ×4 in) wooden-studs. A rectangular base is formed with 2 sections 260 mm (10.23 in) in length, and 2 shorter sections that are 223 mm (8.77 in) in length. The shorter 223 mm (8.77 in) sections are positioned in-between the two 260 mm (10.23 in) sections, at the bottom of Mounting Frame 5, as shown in FIG. 1. The two 223 mm (8.77 in) sections were centered & spaced 85 mm (3.34 in) apart, in-between the 260 mm (10.23 in) sections, in order to accommodate the 2×4 vertical sections that support the Alternator positioned above, with 85 mm (3.34 in) being the width of a 2×4 wooden stud.

FIG. 1 further shows Mounting Frame 5 is comprised of 5 vertical sections, made of 2×4 wooden studs, that support Alternator 7. There are 3 vertical sections in the center of Mounting Frame 5 that are adjacent to each other, that support the center of Alternator 7. These 3 vertical sections are 165 mm (6.49 in) in length. There are two outer vertical sections that are 208 mm (8.18 in) in length, that support the two external arms of Alternator 7. All 2×4 sections are attached with steel screws.

FIG. 1 further shows Alternator 7 is supported with 4 flat right angle brackets that are attached to the vertical 2×4 sections of Mounting Frame 5 with steel screws, with 2 right angle brackets in front, & 2 right angle brackets in the rear of Mounting Frame 5, as shown in FIG. 1. There are two mounting holes that are built-in to each side of the DELCO style Alternator 7. These built-in mounting holes are aligned with the holes in the flat right angle brackets, and are held securely in place with ¼ in steel bolts, nuts and lock washers, as shown in FIG. 1. Mounting Frame 5 is then attached to Wooden-Board 10 with 8 right-angle steel brackets (2 brackets on each side) using steel screws, as shown in FIG. 1.

The instant invention requires adequate belt tension that allows for effective power transmission from v-belt pulley 14 (shown in FIG. 1) to the v-belt drive wheel 6 of Alternator 7. FIG. 1 shows v-belt 11 is attached to v-belt pulley 14 & v-belt drive wheel 6, with adequate belt tension. Adequate Belt tension was achieved by initially attaching Mounting Frames 18 & 12 to Wooden-Board 10 using Right Angle Brackets as shown in FIG. 1, that is achieved with screws tightened with an electric-drill screwdriver, through pre-drilled holes made with an electric-drill & drill bit (for attaching the right angle brackets of Mounting Frames 18 & 12, with steel screws, to Wooden-Board 10.) Then, v-belt 11 is placed into the v-belt groove of v-belt pulley 14 & v-belt drive wheel 6 of Alternator 7. Then, Mounting Frame 5 is slided on the surface of Wooden-Board 10, away from Mounting Frames 18 & 12, while maintaining a straight-line between v-belt pulley 14 & the v-belt drive wheel 6 of Alternator 7, until adequate belt tension was achieved. Then, while holding Mounting Frame 5 in the new position, an outline of the right angle brackets (of Mounting Frame 5), is made in pencil onto Wooden-Board 10. Then, pilot-holes for attachment screws for the right angle brackets (of Mounting Frame 5) are pre-drilled into Wooden-Board 10 with an electric drill & drill bit.

Then, while maintaining the new position (of Mounting Frame 5) where adequate belt tension was achieved, Mounting Frame 5 is attached to Wooden-Board 10, with steel screws, with an electric-drill screwdriver. Belt tension is further tested through visual inspection, and, by turning v-belt pulley 14 by hand, and checking if the v-belt drive wheel 6 of Alternator 7 also turns.

The detailed description of the instant invention in the previous paragraphs is essentially the same as that described in Provisional Patent Application No. 62/328,585 filed on Apr. 27, 2016 by the present inventor William B. Deveer that has the following Title: 2016 Electric Power Generation.

### Operation of the Invention

The instant invention is turned on through Switch 20 (FIG. 1). This turns on Cordless-Drill 16 to 400 RPM, as stated by DeWALT, the manufacturer of Cordless-Drill 16. This also turns Drive-Shaft 33 and 88.9 mm (3.5 in) v-belt pulley 14 at 400 RPM, which in turn, drives the 80 mm (3.14 in) v-belt drive wheel 6 of Alternator 7 to 445 RPM approximately, via v-belt 11, due to the slightly larger pulley ratio. The apparatus is turned off when Switch 20 is turned to the Off position.

The testing results from Apr. 14, 2017 as shown in the inline digital Wattmeter 4 are as follows:

| RPM | WATTS |
|---|---|
| 445 | 19.00 |

This shows that the efficiency of the instant invention is 19% since Cordless-Drill 16 requires 100 watts (20 volts DC×5 amps.)

The Best Mode of Operation for the instant invention, in it's present form, without any further development, is when it is used as a demonstration prototype of a new power generation methodology, for review by private sector Research & Development (R & D) Institutes, and government organizations such as the Department of Energy, in order to gain funding for large scale R & D into this new method of power generation, that does not cause air pollution, which does not require an internal combustion engine, nor wind-power nor hydro-power, in order to generate electricity, utilizing the Tesla Generator, which will serve as an immediate benefit for the public.

1. An electric power generation apparatus utilizing an efficient & high-torque direct current electric motor that turns an Alternator, a version of the 1896 Tesla generator, without utilizing an internal combustion engine, nor wind-power, nor hydro-power, nor connection to the electric grid, comprising of:
a. an efficient & high-torque direct current (dc) electric motor within a cordless-drill connected to a hole-saw attachment, wherein a keyed drive shaft is fitted into the hollow tubing of said hole saw attachment,
b. said keyed drive shaft is also placed through the bore of a v-belt pulley, wherein an automotive v-belt is placed, and, said drive shaft is then inserted into a flange-type ball bearing,
c. said automotive v-belt is also placed into the v-belt drive pulley of said Alternator, means for turning said Alternator in order to generate electricity,
d. said Alternator's ground being connected to a dedicated grounding method comprised of a rectangular metal frame,
e. said Alternator, said cordless-drill, and said ball-bearing, are affixed to strong mounts made from pressure treated two-by-four wooden studs,
f. said efficient & high torque dc motor within said cordless-drill is powered initially by a starter-battery,
g. after said electric power generation apparatus is in operation, a loop of electric current from said Alternator's output is sent through said starter-battery's connection to said cordless-drill, thereby lowering the power required from said starter-battery for powering said cordless-drill, thus forming an apparatus that creates a means for generating electricity without utilizing an internal combustion engine, nor wind-power, nor hydro-power, nor connection to the electric grid.
